(19) United States
(12) Patent Application Publication
(10) Pub. No.: US 2008/0084619 A1
(43) Pub. Date: Apr. 10, 2008

(54) LENS BARREL ASSEMBLY OF CAMERA MODULE AND LASER APPARATUS FOR ASSEMBLING THE SAME

(75) Inventor: Young Ho Lee, Yongin (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/905,750

(22) Filed: Oct. 3, 2007

(30) Foreign Application Priority Data
Oct. 10, 2006 (KR) 10-2006-98593

(51) Int. Cl. G02B 7/02; B23K 26/00

(52) U.S. Cl. 359/820; 219/121.6; 359/819

(57) ABSTRACT

A lens barrel assembly of a camera module and a laser apparatus for assembling the lens barrel assembly are provided. The lens barrel assembly includes a barrel in which at least one lens is received, the barrel having a stopping protrusion in a lower-end inner surface thereof to stop the lens; and a retainer having a horizontal portion which has a lens exposing hole and covers an upper opening of the barrel and a vertical portion which is formed to extend from an outer circumference of the horizontal portion in the optical-axis direction and which an outer surface of the barrel is inserted into, wherein an overlapped region of the barrel and the horizontal portion is fuse-secured by laser illumination.

### CROSS-REFERENCE TO RELATED APPLICATIONS

This application claims the priority of Korean Patent Application No. 2006-98593 filed on Oct. 10, 2006, in the Korean Intellectual Property Office, the disclosure of which is incorporated herein by reference.

### BACKGROUND OF THE INVENTION

1. Field of the Invention

The present invention relates to a lens barrel assembly of a camera module and a laser apparatus for assembling the lens barrel assembly, and more particularly, to a lens barrel assembly of a camera module capable of improving workability and productivity by conveniently and speedily performing a process of permanently assembling a barrel and a retainer without a screw coupling process, a bonding coating process, or a bonding curing process and reducing production cost by increasing the number of cavities of a mold and a laser apparatus for assembling the lens barrel assembly.

2. Description of the Related Art

Generally, in a current portable communication terminal such as a mobile phone, PDA (personal digital assistant), and a portable PC (personal computer), transmission of text, voice, and image data have been widely used.

Under the circumstances, a camera module for transmission of image data or image chatting is provided as a basic module to the current portable communicant terminal.

FIG. 1 is a perspective exploded view illustrating a general camera module 1. The camera module 1 includes a lens barrel assembly 10 in which a lens L is disposed. The lens barrel assembly 10 includes a barrel 10a of which outer surface is provided with a male screw 11 and a retainer 10b which is coupled with an upper end of the barrel 10a to secure the lens L. A light incident hole 13, that is, a lens exposing hole is formed on a central region of an upper surface of the retainer to penetrate the upper surface.

The lens barrel assembly 10 is coupled with a housing 20 having an inner cylindrical space. An inner surface of the inner cylindrical space is provided with a female screw 21 that is engaged with the female screw 11 of the barrel 10a. An IR filter 25 which filters light transmitting the lens L is disposed on a bottom of the inner cylindrical space.

A board 40 on which an image sensor 30 having an imaging region for imaging an object from the light transmitting the lens L is mounted is disposed under the housing 20. The lower end of the housing 20 is mounted on the one end portion of the board 40, and a connector 45 which is electrically connected to a display means (not shown) is provided to the other end portion of the board 40.

In a case where the image sensor 30 is subject to flip-chip bonding, a window 42 for exposing the imaging region is formed to be opened in the one end portion of the board 40.

A process of assembling the lens or a plurality of the lenses in the lens barrel assembly 10 of the camera module 1 is as follows. As shown in FIGS. 2 and 3, a plurality of the lenses are sequentially inserted and stacked in the arrow direction A from the upper portion to the lower portion of the barrel 10a. At this time, a spacer(s) 15 is disposed so as to maintain an interval between the lenses L.

Next, the retainer 10b is coupled with the male screw 11 formed on an upper-end surface of the barrel 10a so as to secure the lenses L stacked in the barrel 10a, so that the temporarily-assembled lens barrel assembly 10 in which the lenses are temporarily assembled is obtained.

In FIGS. 2A and 2B, reference numeral 19 denotes a stopping protrusion for preventing the lenses from being separated downward.

As shown in FIG. 3A, the lens barrel assembly 10 in which the lenses L stacked in the barrel 10a is temporarily secured by the retainer 10b is mounted on a binding jig (not shown). Next, while the lens barrel assembly is rotated in the arrow direction B, a boundary region between the outer surface of the barrel 10a and the inner surface of the retainer 10b is uniformly coated with a UV bonding material 9 by using a dispenser 3. Next, a UV curing process is performed.

As shown in FIG. 3B, in the UV curing process, the UV bonding material 9 coated in the lens barrel assembly 10 is cured by a UV beam illuminated from a UV lamp 6 which is disposed corresponding to the UV bonding material 9, so that the permanently-assembled lens barrel assembly 10 in which the retainer 10b is permanently secured to the barrel 10a is obtained.

In the conventional process of permanently securing the retainer 10b to the barrel 10a in which the lenses L are stacked, the screw coupling method is used. Namely, the male screw 11 provided to the outer surface of the barrel 10a is coupled with the female screw of the retainer lob. In the screw coupling method, the assembling task is very complicated, and excessively long time is taken to perform the assembling task. In addition, if the screws are released from each other, defective focusing may occur, and various assembling defects may occur.

In addition, the number of cavities of a mold for forming the barrel is limited to 4 due to under-cut of the screws. Therefore, there is a limitation to reduction of production cost of the lens barrel assembly. The cost of the mold and the production cost thereof are increased

### SUMMARY OF THE INVENTION

As aspect of the present invention provides a lens barrel assembly of a camera module capable of improving workability and productivity by conveniently and speedily performing a process of permanently assembling a barrel and a retainer without a screw coupling process, a bonding coating process, or a bonding curing process and reducing production cost by increasing the number of cavities of a mold and a laser apparatus for assembling the lens barrel assembly.

According to an aspect of the present invention, there is provided a lens barrel assembly of a camera module, comprising: a barrel in which at least one lens is received, the barrel having a stopping protrusion in a lower-end inner surface thereof to stop the lens; and a retainer having a horizontal portion which has a lens exposing hole and covers an upper opening of the barrel and a vertical portion which is formed to extend from an outer circumference of the horizontal portion in the optical-axis direction and which an outer surface of the barrel is inserted into, wherein an overlapped region of the barrel and the horizontal portion is fuse-secured by laser illumination.

The barrel may be formed as a screwless hollow-cylindrical member which is inserted into the horizontal portion of the retainer.

The barrel may further comprise a spacer for maintaining an interval between adjacent lenses, and the overlapped region may be disposed to a position corresponding to the spacer.

The spacer may be made of a heat-resistance material.

The outer surface of the body of the barrel and an inner surface of the vertical portion may be in a surface contact with each other and vertically assembled in the overlapped region.

According to another aspect of the present invention, there is provided a laser apparatus for assembling a lens barrel assembly, comprising: a lens barrel assembly having a barrel in which at least one lens is received, a retainer which is coupled with an upper-end portion of the barrel, and an overlapped region of the barrel and retainer; a mounting jig in which the lens barrel assembly is mounted; and a laser generator which is electrically connected through an optical-fiber cable to a laser output terminal disposed to a position corresponding to the overlapped region of the lens barrel assembly to illuminate the overlapped region with a laser beam having a specific frequency range.

The mounting jig may be formed on an upper surface of a base disposed on a bottom surface, and the mounting jig may be provided with a mounting opening having a predetermined depth in which the lens barrel assembly is mounted.

The laser output terminal may selectively illuminate any one of a solid-laser beam, a gas-laser beam, and a liquid-laser beam.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective exploded view illustrating a general camera module;

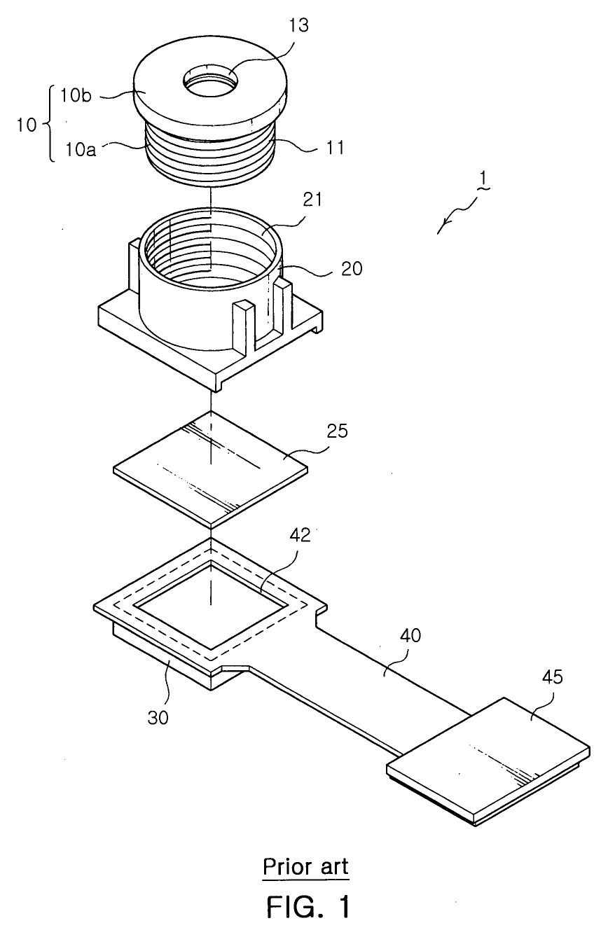

FIG. 2 illustrates states of a conventional lamp where a lens barrel assembly is temporarily assembled, FIG. 2A is a view illustrating a state that a lens is stacked on a barrel, and FIG. B is a view illustrating a state that a retainer is assembled to the barrel;

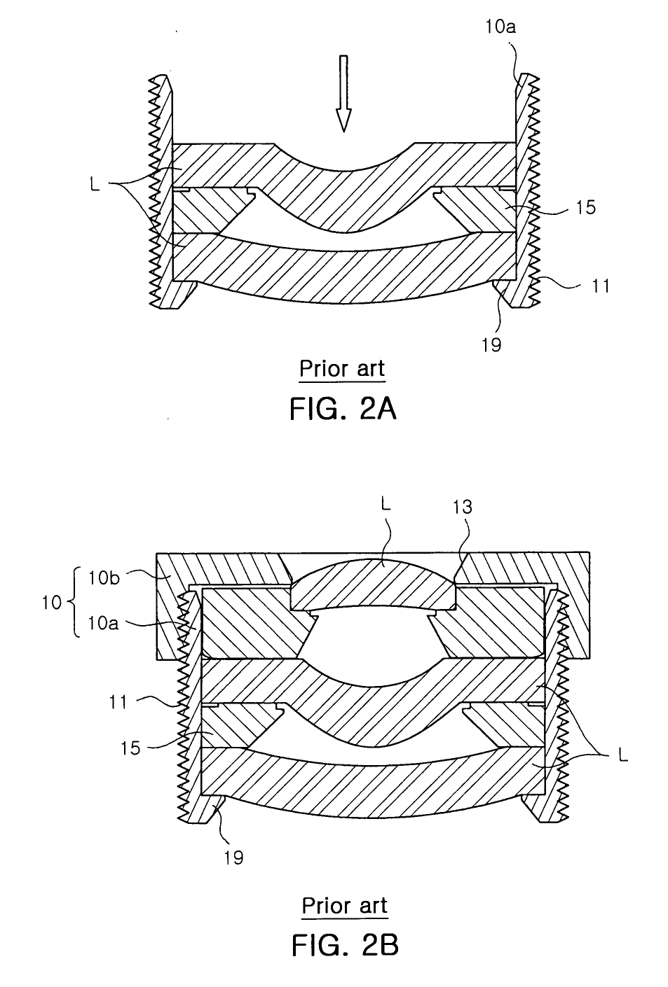

FIG. 3 illustrates states of the conventional lamp where the lens barrel assembly is permanently assembled, FIG. 3A is a view illustrating a state that a UV bonding material is coated between the barrel and the retainer, and FIG. 3B is a view illustrating a state that the coated UV bonding material is cured;

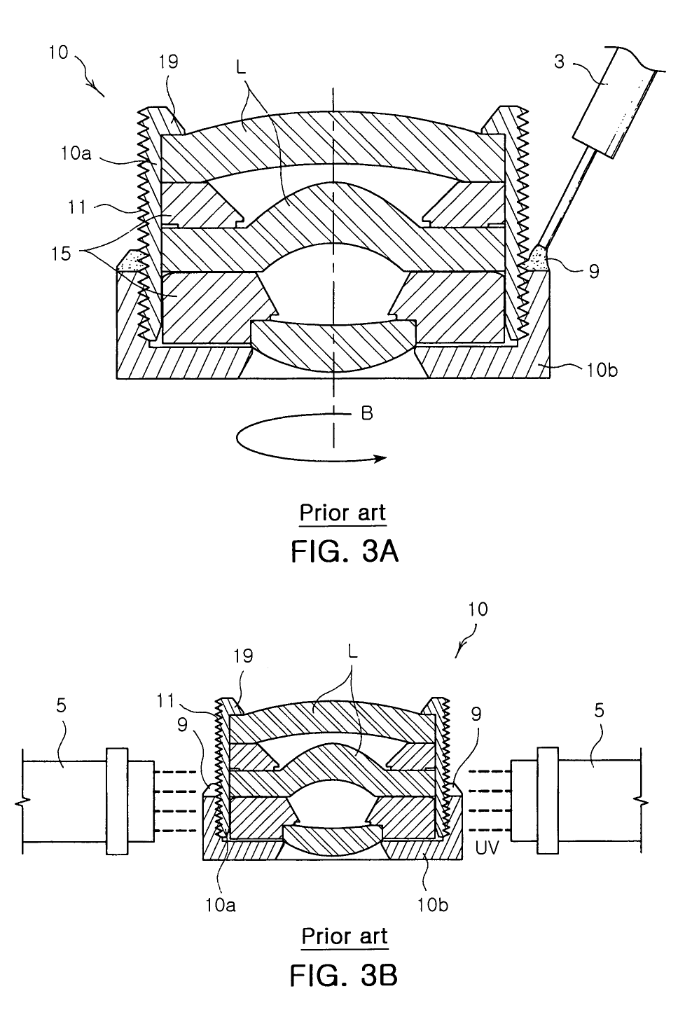

FIG. 4 is a view illustrating a construction of a lens barrel assembly of a camera module according to the present invention;

FIG. 5 is a view illustrating a process of fuse-securing the lens barrel assembly of the camera module by using a laser apparatus;

FIG. 6 is a cross-sectional view illustrating the lens barrel assembly in a fuse-secured state obtained by using a laser apparatus according to the present invention;

FIG. 7 illustrates a fuse-secured state of an overlapped region of a barrel and a retainer according to a temperature; and

FIGS. 8A and 8B are schematic views illustrating bonding configurations between different-type materials and between the same-type materials in the lens barrel assembly, respectively.

### DETAILED DESCRIPTION OF THE PREFERRED EMBODIMENT

Hereinafter, exemplary embodiments of the present invention will now be described in detail with reference to the accompanying drawings.

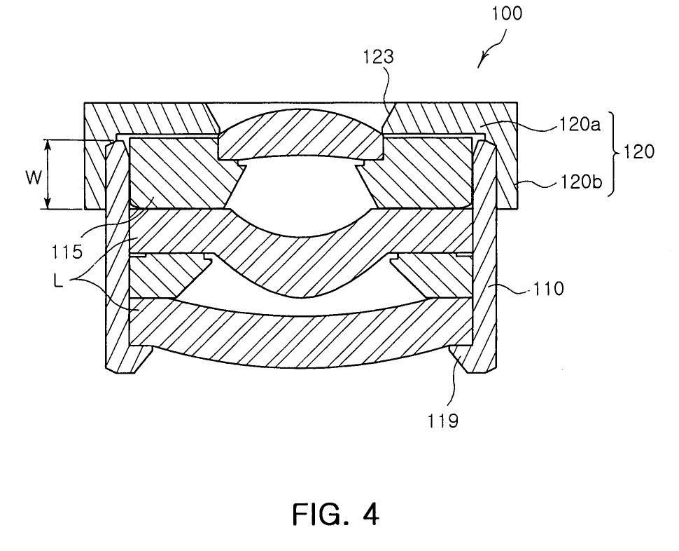

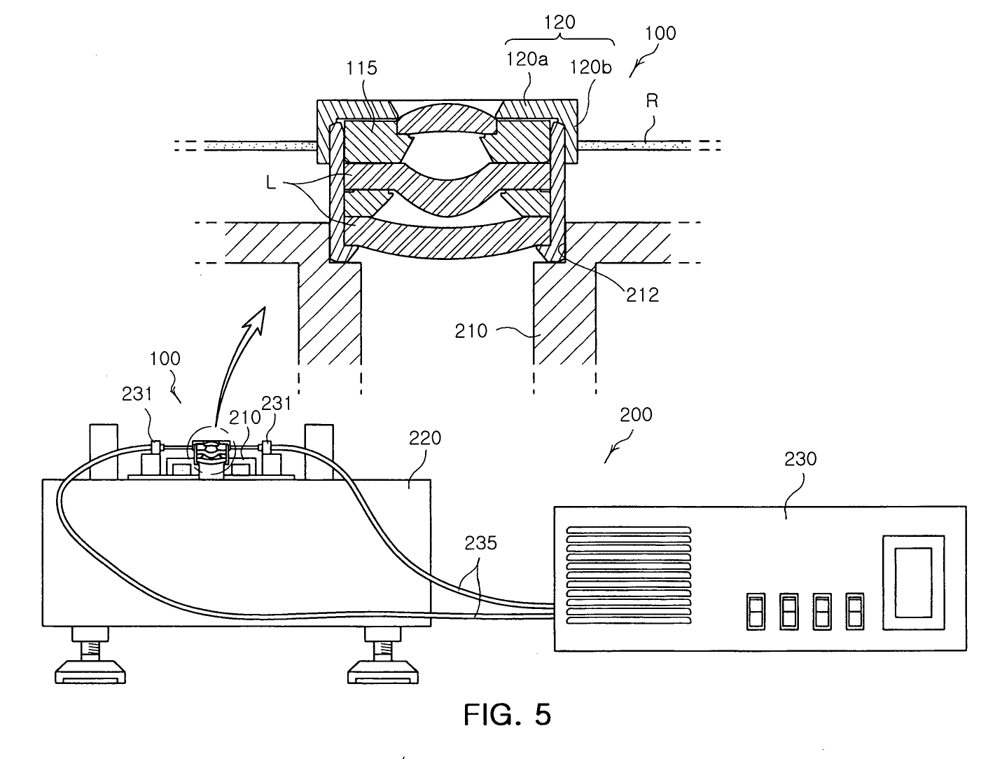

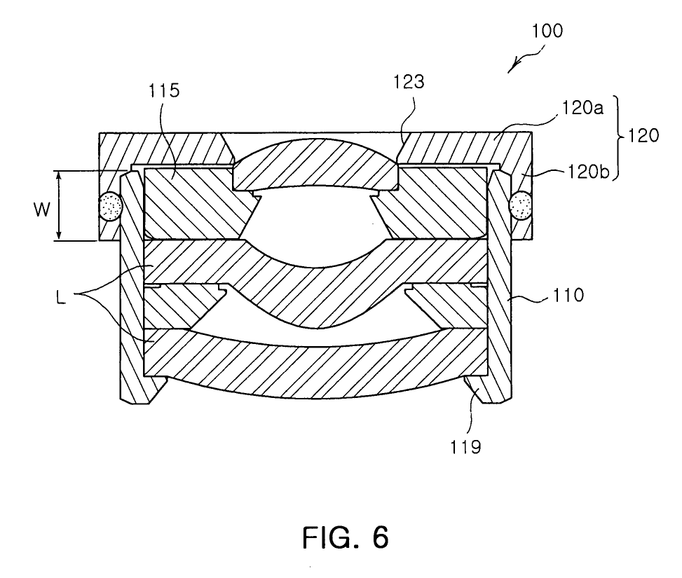

FIG. 4 is a view illustrating a construction of a lens barrel assembly of a camera module according to the present invention. FIG. 5 is a view illustrating a process of fuse-securing the lens barrel assembly of the camera module by using a laser apparatus. FIG. 6 is a cross-sectional view illustrating the lens barrel assembly in a laser-fused state according to the present invention.

As shown in FIGS. 4 to 6, the lens barrel assembly 100 according to the present invention includes a barrel 100 and a retainer 120, which are presently assembled to each other by fuse-securing an overlapped region with a laser.

The barrel 110 is a hollow-cylindrical lens receiving member, in which at least one lens L is inserted in a direction from a lower portion to an upper portion of the barrel 110 to be stacked. The barrel 110 is made of a resin.

The barrel 110 is provided with a stopping protrusion 119 for stopping the lowermost lens L among a plurality of the lenses L stacked in the vertical direction. The stopping protrusion 119 is formed on a lower-end inner surface of the barrel 110 in an inner circumferential direction to protrude in the inward direction so as to prevent the lowermost lens L from being separated downwards.

A screwless region is formed on an outer surface of a body of the barrel 110, so that the barrel can be inserted into the retained in the direction from the lower portion to the upper portion of the barrel 110.

The screwless region may be formed on various portions of the barrel 110 according to manners of assembling the barrel 110 with the housing 20. In a case where the barrel 110 is engaged with a female screw 21 of the housing 20 in a screw coupling manner, the screwless region is formed on a portion of an upper-end outer surface of the body of the barrel 110 corresponding to a horizontal portion 120b of the retainer 120. In a case where the barrel 110 is inserted in to an inner cylindrical space of the housing 20 in a screwless coupling manner, the screwless region is formed on the entire outer surface of the body of the barrel 110.

The barrel 110 may be provided with an iris diaphragm (not shown) together with a plurality of the lenses L. The iris diaphragm is disposed between the stacked lens Land an adjacent lens.

Preferably, spacers 115 are additionally disposed between the lenses L so as to maintain predetermined intervals therebetween.

The upper most lens L that is in contact with the retainer 120, that is, the lens disposed on the uppermost layer among a plurality of the lenses L in the barrel 110 may be substituted with an IR filter which filters infrared light. Alternatively, the IR filter may be disposed on an intermediate layer which is a layer between the lenses L or on the lowermost layer where the lowermost lens L stopped by the stopping protrusion 119 is disposed.

The retainer 120 is secured to the barrel 110 by inserting the upper end of the barrel 110 into the retainer in the optical-axis direction from the lower portion to the upper portion of the barrel 110. Namely, the retainer 120 is a fixing member for fixing positions of the lenses L in the barrel 110 by pressing the stacked lenses L in the barrel 110 downwards.

The retainer 120 includes a horizontal portion 120a which covers an upper-end opening of the barrel 110 and a cylindrical vertical portion 120b which is formed to extend from an outer circumference of the horizontal portion 120a in the optical-axis direction. The horizontal portion 120a of the retainer 120 is provided with a lens exposing hole 123 having a predetermined size for exposing the lens L. The lens exposing hole 123 is formed to penetrate a central region of the horizontal portion 120a.

Preferably, an inner diameter of the vertical portion 120b is designed to be equal to or slightly smaller than an outer diameter of the barrel 110, so that the barrel 110 can be forcibly inserted into the vertical portion 12b.

After the barrel 110 and the retainer 120 are temporarily assembled to form an overlapped region W of the outer surface of the barrel 110 and the inner surface of the vertical portion 120b, a portion of the overlapped region W is fuse-secured by an external heat source, that is, a laser, and the overlapped region is cured. As a result, the barrel 110 and the retainer 120 are permanently assembled to each other.

In other words, the outer surface of the body of the barrel 110 and the inner surface of the vertical portion 120b are in a surface contact with each other and vertically assembled in the overlapped region W.

Preferably, the overlapped region W is disposed corresponding to the spacer 115 that is disposed in the barrel 110 to maintain an interval between the adjacent lenses L. Preferably, the spacer is made of a heat-resistance material.

Due to the heat-resistance material, transfer of heat generated in the laser fuse-securing process can be minimized or prevented, so that it is possible to suppress defective products caused from a deformation of lens.

As shown in FIG. 4, the temporarily-assembled lens barrel assembly obtained by inserting the barrel 100 (in which a plurality of the lenses L are stacked) into the vertical portion 120b of the retainer 120 is fuse-secured by using a laser beam generated from the laser apparatus 200 shown in FIG. 5 as a heat source, so that the permanently-assembled lens barrel assembly is obtained.

The laser apparatus 200 is constructed with a mounting jig 210 and a laser generator 230.

The retainer 120 of the lens barrel assembly in which at least one lens is received is mounted on the mounting jig 210. The mounting jig 210 having a predetermined depth is provided with a mounting hole 212 on an upper surface thereof, so that the lens barrel assembly 100 can be vertically disposed.

Preferably, the mounting jig 210 is disposed on an upper surface of a base 220 provided on a bottom surface.

The laser generator 230 is connected to a laser output terminal 231 which faces the overlapped region W of the lens barrel assembly 100 mounted on the mounting jig 210. The laser output terminal 231 is connected through an optical-fiber cable.

When a power is supplied to the laser generator 230, the overlapped region W of the outer surface of the barrel 110 and the inner surface of the retainer 120 is intensively illuminated with the laser beam having a specific frequency range which is generated by the laser generator 230 and transmitted through the optical-fiber cable 230 to the laser output terminal 231.

The laser generator 230 includes a laser generating unit for generating a laser beam having a predetermined frequency range, a power supply, and a ballast for stabilizing the laser beam into a suitable frequency range.

Now, processes for permanently assembling the temporarily-assembled lens barrel assembly 100 in which the upper-end portion of the barrel 110 is inserted into the retainer 120 in the screwless manner by using the laser apparatus 200 is described. Firstly, as shown in FIG. 5, the temporarily-assembled lens barrel assembly 100 is mounted on the mounting hole 212 of the mounting jig 210. The laser output terminal 231 is disposed to face the overlapped region W in a predetermined separation distance at the same horizontal level.

Subsequently, the laser generator 230 is powered on to generate a laser beam having a specific frequency range. The laser beam is transmitted through the optical-fiber cable 235 to the laser output terminal 231 that is coupled with the end of the optical-fiber cable 234, so that the laser beam is emitted from the laser output terminal 231.

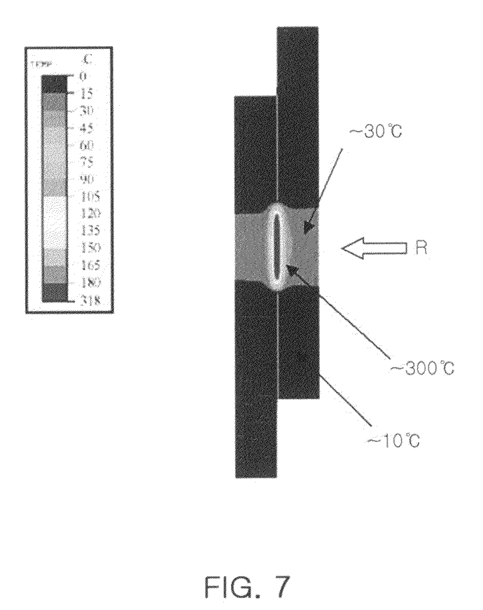

As shown in FIG. 7, when the laser beam emitted from the laser output terminal 231 is illuminated on a specific portion of the overlapped region W, the barrel 110 that is made of a resin is firstly fused by using the laser beam as a heat source. Subsequently, while the vertical portion 120b of the retainer 120 is fused, the specific portion of the barrel and the vertical portion are fuse-secured to each other.

Namely, the specific portion of the overlapped region W facing the laser output terminal 231 is fuse-secured by the laser beam R illuminated from the laser output terminal 231 only the localized bonding portion, that is, the specific portion illuminated with the laser beam R is heated up to a fusing temperature of 150° C. or more of a heat-resistant extracting resin constituting the barrel 110 and the retainer 120, and preferably, the specific portion is maintained in a heating temperature range of 150 to 300° C. so that the bonding portion is fused and secured. The increase in temperature is concentrated on the bonding portion, that is, the specific portion illuminated with the laser beam. Therefore, deformation does not occur in a region except for the fuse-secured portion.

The laser output terminal 215 that illuminates the laser beam R has a diameter of 0.5 to 3φ. The laser output terminal 215 is provided to the end of an optical-fiber cable 235 which includes a bundle of optical fibers.

The frequency of the laser beam R illuminated from the laser output terminal 231 is set to be in a specific frequency range so that only the specific portion in the overlapped region of the retainer 120 and the barrel 110 which is extracted and molded from a heat-resistant resin can be fuse-secured. Any one of a solid-laser beam, a gas-laser beam, and a liquid-laser beam can be selected according to the set frequency range.

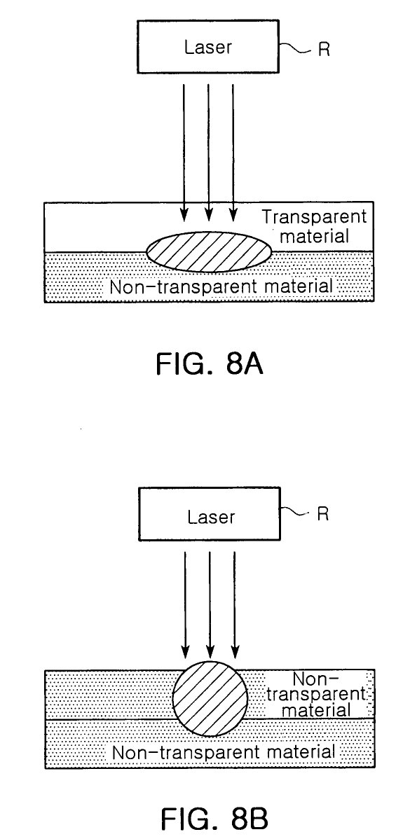

FIGS. 8A and 8B are schematic views illustrating bonding configurations between different-type materials and between the same-type materials in the lens barrel assembly, respectively.

A transparent member transmits the laser beam R illuminated from the laser output terminal 231, and the illuminated portions of the non-transparent members are fused by the laser beam R. Therefore, as shown in FIG. 8A, in a case where the different-type materials, that is, the transparent member and the non-transparent member are bonded by illumination of the laser beam R, only the non-transparent member is fused by the laser beam R transmitting the transparent member.

On the other hand, as shown in FIG. 8B, in a case where the same-type materials, that is, the non-transparent members are bonded by illumination of the laser beam R, both the non-transparent members are fused by the laser beam R, so that the fusing is formed from the illuminated surface of the first non-transparent member down to a portion of the second non-transparent member. Therefore, the same-type material members can be more strongly fuse-secured.

Preferably, the frequency of the laser beam R is adjusted in a suitable frequency range so that the only illuminated portion can be fused to bond the same-type members or the different-type members.

Next, in a case where the lens barrel assembly 100 assembled by performing the laser fuse-securing process using the laser apparatus 200 is not provided with the male screw on the outer surface of the body of the barrel 110, the lens barrel assembly 100 is inserted into the housing 20 in the optical-axis direction and coupled with the inner surface thereof in the screwless coupling manner. On the other hand, in a case where the lens barrel assembly 100 is provided with the male screw on the outer surface of the body of the barrel 110, the lens barrel assembly 100 is coupled with the inner surface thereof in the screw coupling manner.

Finally, the board 40 on which the image sensor 30 is mounted in a flip-chip bonding manner or a wire bonding manner is provided on the lower end of the housing 20 in which the lens barrel assembly is coupled in the screwless or screw coupling manner, so that the camera module 1 is manufactured.

According to the present invention, a barrel and a retainer is permanently assembled by fuse-securing a specific portion of an overlapped region of the barrel and the retainer with illumination of a laser beam as a heat source emitted from a laser output terminal facing the specific portion. Therefore, unlike a conventional lens barrel assembly, the process of permanently assembling the barrel and the retainer is conveniently and speedily performed without a screw coupling process, a bonding coating process, or a bonding curing process, so that it is possible to effectively improve workability and productivity.

In addition, the number of cavities of a mold which is used to extract and mold the barrel can be increased, so that it is possible to improve mold productivity. Accordingly, it is possible to reduce production cost.

While the present invention has been shown and described in connection with the exemplary embodiments, it will be apparent to those skilled in the art that modifications and variations can be made without departing from the spirit and scope of the invention as defined by the appended claims.

What is claimed is:

1. A lens barrel assembly of a camera module, comprising:
a barrel in which at least one lens is received, the barrel having a stopping protrusion in a lower-end inner surface thereof to stop the lens; and
a retainer having a horizontal portion which has a lens exposing hole and covers an upper opening of the barrel and a vertical portion which is formed to extend from an outer circumference of the horizontal portion in the optical-axis direction and which an outer surface of the barrel is inserted into,
wherein an overlapped region of the barrel and the horizontal portion is fuse-secured by laser illumination.

2. The lens barrel assembly of claim 1, wherein the barrel is formed as a screwless hollow-cylindrical member which is inserted into the horizontal portion of the retainer.

3. The lens barrel assembly of claim 1,
wherein the barrel further comprises a spacer for maintaining an interval between adjacent lenses, and
wherein the overlapped region is disposed to a position corresponding to the spacer.

4. The lens barrel assembly of claim 3, wherein the spacer is made of a heat-resistance material.

5. The lens barrel assembly of claim 1, wherein the outer surface of the body of the barrel and an inner surface of the vertical portion are in a surface contact with each other and vertically assembled in the overlapped region.

6. A laser apparatus for assembling a lens barrel assembly, comprising:
a lens barrel assembly having a barrel in which at least one lens is received, a retainer which is coupled with an upper-end portion of the barrel, and an overlapped region of the barrel and retainer;
a mounting jig in which the lens barrel assembly is mounted; and
a laser generator which is electrically connected through an optical-fiber cable to a laser output terminal disposed to a position corresponding to the overlapped region of the lens barrel assembly to illuminate the overlapped region with a laser beam having a specific frequency range.

7. The laser apparatus of claim 6,
wherein the mounting jig is formed on an upper surface of a base disposed on a bottom surface, and
wherein the mounting jig is provided with a mounting opening having a predetermined depth in which the lens barrel assembly is mounted.

8. The laser apparatus of claim 6, wherein the laser output terminal selectively illuminates any one of a solid-laser beam, a gas-laser beam, and a liquid-laser beam.
